(19) United States
(12) Patent Application Publication
(10) Pub. No.: US 2021/0324173 A1
(43) Pub. Date: Oct. 21, 2021

(54) COMPOSITIONS AND METHODS FOR USE IN PLASTICS MANUFACTURING

(71) Applicants: Charles B. Irish, Westfield, NJ (US); Paul S. Maguire, Thornton, PA (US); Stephen B. Maguire, West Chester, PA (US)

(72) Inventors: Charles B. Irish, Westfield, NJ (US); Paul S. Maguire, Thornton, PA (US); Stephen B. Maguire, West Chester, PA (US)

(73) Assignee: ., Kanazawa-shi (JP)

(21) Appl. No.: 17/233,583

(22) Filed: Apr. 19, 2021

Related U.S. Application Data
(60) Provisional application No. 63/012,544, filed on Apr. 20, 2020.

(51) Int. Cl. C08K 5/00; C08K 11/00; C09K 11/06; B29C 48/29; B29C 48/00; B29C 48/505

(52) U.S. Cl. CPC C08K 5/0033; C08K 5/0041; C08K 11/00; B29K 2105/0017; B29C 48/29; B29C 48/022; B29C 48/505; C09K 11/06

(57) ABSTRACT

Compositions and methods for making biodegradable plastic products are provided. The compositions include a destabilizing agent that makes the finished plastic biodegradable. The compositions also can include an oil-based carrier, such as cottonseed oil, that allows the biodegrading agent to be metered into a continuous plastic manufacturing process. The compositions further can include an additive that allows the biodegrading additive to combine with the carrier; an optical brightener to improve the appearance of the finished plastic product, and to indicate the presence of the composition in the finished product; and a pigment, so that the composition can act as a liquid coloring agent.

This application claims the benefit under 35 U.S.C. 119(e) of U.S. provisional application No. 16/012,544, filed Apr. 20, 2020, the contents of which are incorporated by reference herein in their entirety.

### INCORPORATION BY REFERENCE

The contents of U.S. Pat. Nos. 3,468,904 A; 3,488,204 A; 4,921,132 A; 7,201,290 B2; 8,042,578 B2; 8,627,852 B2; and United States patent application publication nos. U.S. 2002/0122103 A1; 2002/0189667 A1; 2003/0071868 A1; and U.S. 2005/0126638 A1 are incorporated by reference herein in their entireties.

### BACKGROUND OF THE INVENTION

### Field of the Invention

The disclosed technology involves compositions for use in plastics manufacturing. In one of its aspects, the compositions comprise a destabilizing agent that causes plastic to degrade over time, and an oil-based liquid carrier such as cottonseed oil.

### Description of the Prior Art

Plastic is a highly durable material widely used throughout the world. While the durability of plastic, in general, is an advantage while the plastic is in use, it can become a disadvantage once the plastic is discarded. In particular, plastic can take hundreds, or even thousands of years to degrade. Thus, plastic that has been disposed of improperly can form unsightly litter; can be harmful to land and water-based wildlife; and can consume large volumes in landfills.

Destabilizing additives that cause plastic to degrade have been developed. For example, destabilizing agents contribute to or cause chemical changes, such as oxidation, water degradation, and biodegradation, in the finished plastic product so that the product readily can be recycled, or will breakdown in an accelerated fashion into environmentally acceptable compounds, typically ordinary wax. Destabilizing agents, in general, cannot be metered directly into a continuous plastic manufacturing process such as extrusion or injection molding. Rather, the destabilizing agent needs to be combined with some sort of carrier in order to be metered into the manufacturing process.

### SUMMARY

The disclosed technology relates a composition for use in molding or extruding plastic products, where the composition includes a liquid carrier and a destabilizer.

In another aspect of the disclosed technology, the composition further includes an optical brightener.

In another aspect of the disclosed technology, the destabilizer includes TIMEPLAST™.

In another aspect of the disclosed technology, the liquid carrier includes cottonseed oil.

In another aspect of the disclosed technology, the composition further includes an additive that facilitates combining of the liquid carrier and the destabilizer.

In another aspect of the disclosed technology, the composition further includes pigment.

In another aspect of the disclosed technology, the optical brightener is configured to fluoresce when exposed to ultraviolet light.

In another aspect of the disclosed technology, the destabilizer is configured to cause a decrease in the molecular weight of a polymer.

In another aspect of the disclosed technology, a liquid colorant for use in manufacturing plastics includes a destabilizer, a liquid carrier, and pigment.

In another aspect of the disclosed technology, the destabilizer includes TIMEPLAST™.

In another aspect of the disclosed technology, the liquid carrier includes cottonseed oil.

In another aspect of the disclosed technology, the composition further includes an additive that facilitates combining of the liquid carrier and the destabilizer.

In another aspect of the disclosed technology, the destabilizer is configured to cause a decrease in the molecular weight of a polymer.

In another aspect of the disclosed technology, a method of molding or extruding plastic parts includes providing a quantity of destabilizer; providing a quantity of liquid carrier; combining the destabilizer and the liquid carrier to produce a composition; and adding the composition to thermoplastic resin in the course of molding or extrusion.

In another aspect of the disclosed technology, the method further includes providing an optical brightener; and combining the destabilizer, the liquid carrier, and the optical brightener to produce the composition.

In another aspect of the disclosed technology, the method further includes providing an additive that facilitates combining the liquid carrier and the destabilizer; and combining the destabilizer, the liquid carrier, the optical brightener, and the additive to produce the composition.

In another aspect of the disclosed technology, the destabilizer includes TIMEPLAST™.

In another aspect of the disclosed technology, the liquid carrier includes cottonseed oil.

In another aspect of the disclosed technology, the optical brightener is configured to fluoresce when exposed to ultraviolet light.

In another aspect of the disclosed technology, the destabilizer is configured to cause a decrease in the molecular weight of a polymer.

In another aspect of the disclosed technology, the method further includes providing pigment; and combining the destabilizer, the liquid carrier, and the pigment to produce the composition, wherein the composition is a liquid colorant.

In another aspect of the disclosed technology, a method of molding or extruding plastic parts includes the steps of providing a collection of pigments in powder form, providing a quantity of cottonseed oil, providing a quantity of destabilizer, and creating a plurality of single pigment dispersions each in a cottonseed oil carrier, the cottonseed oil carrier including the cottonseed oil and the destabilizer. The method further includes blending selected ones of the single pigment dispersions to create a blend of a desired color shade, milling the blend, and adding the blend to thermoplastic resin in the course of molding or extrusion.

In another aspect of the disclosed technology, the pigment in each of the dispersions includes from about 50% to about 70% by weight of the dispersion.

In another aspect of the disclosed technology, the pigment in each of the dispersions includes from about 25% to about 80% by weight of the dispersion.

In another aspect of the disclosed technology, the pigment in the blend of the dispersions includes from about 25% to about 80% by weight of the blend.

In another aspect of the disclosed technology, a method of making liquid color for use in the course of molding or extruding plastic parts includes providing a collection of pigments in powder form, providing a quantity of cottonseed oil, providing a quantity of destabilizer, and creating a plurality of single pigment dispersions, each in a cottonseed oil carrier, the cottonseed oil carrier including the cottonseed oil and the destabilizer. The method further includes blending selected ones of the single pigment dispersions to create a blend of a desired color shade, and milling the blend.

In another aspect of the disclosed technology, the pigment in the blend of the dispersions includes from about 25% to about 80% by weight of the blend.

In another aspect of the disclosed technology, the method further includes adding at least one additive selected from the group including lubricants, blowing agents, light stabilizers, nucleating agents, antistatic agents and antioxidants, to the blend.

In another aspect of the disclosed technology, a method of fabricating plastic products having a preselected color includes preparing a dispersion of pigment of the preselected color in cottonseed oil and destabilizer, supplying a preselected plastic resin for the product to be fabricated to a process machine having a rotating screw, furnishing the dispersion to the process machine at a position adjacent to threaded portion of the rotating screw, and blending the dispersion and the resin by rotating the screw.

In other aspects of the disclosed technology, plastic parts manufactured by the above methods are provided.

### DESCRIPTION OF THE INVENTION

A composition for making biodegradable plastic products is provided. The composition can be used to make biodegradable plastic with additional desirable properties, such as improved strength and lubricity. The blend includes a destabilizing agent that makes the finished plastic biodegradable. The blend also includes an oil-based carrier, such as cottonseed oil, that allows the biodegrading agent to be metered into a continuous plastic manufacturing process. The composition further can include an additive that allows the biodegrading additive to combine with the carrier. The composition also can include an optical brightener to improve the appearance of the finished plastic product, and to indicate the presence of the composition in the finished product. The composition also can include a pigment, so that the composition can act as a liquid coloring agent.

The destabilizing agent contributes to or causes chemical changes, such as oxidation, water degradation, and biodegradation in the finished plastic product so that the plastic product readily can be recycled, or will break down in an accelerated fashion into environmentally acceptable compounds, typically ordinary wax. The destabilizing agent can work, for example, by causing a decrease in the molecular weight of the polymer being molded or extruded, resulting in the polymer losing structural integrity. Among such destabilizing agents are mixtures of heptane, cellulose, methyl rhenium trioxide, butylated hydroxytoluene and polyphenol oxidase; organics including brevibacillus borstelensis, rhodococcus rubber, pseudomonas chlororaphis and comamonas acidovorans; ketone carbonyl; carbon monoxide carbonyl; starches; salts of metals including iron, cobalt and nickel.

A suitable destabilizer is available commercially from Bioplast LLC of Coral Gables, Florida, under the trade name TIMEPLAST™; and is described in U.S. Pat. No. 9,181,412, the contents of which are incorporated by reference herein in their entirety. In its basic form, TIMEPLAST comprises the following constituent elements: heptane, cellulose, methyl rhenium trioxide, butylated hydroxytoluene, and polyphenol oxidase.

TIMEPLAST is made by using heptane to partially desynthesize a sample of the plastic material to which the TIMEPLAST eventually will be added. The resulting mix is combined, at 75 percent of the sample plastic's melting temperature, with the cellulose, methyl rhenium trioxide, butylated hydroxytoluene, and polyphenol oxidase. The relative percentage of the heptane is related to the molecular weight (g/mol) of the sample plastic (SP). Different types of plastic require a different amount of heptane in this step.

TIMEPLAST can be formulated in accordance with the following exemplary process.

CA, CB, CC and CD=compounds A, B, C and D, respectively.

BA=TIMEPLAST

PD=amount of actual production demand of the plastic that was sampled

(SP<100%>+Heptane Volumetric in solution approach until solute (SP) partially dissolves into the solvent (Heptane)=CA (1)

According to Equation (1), heptane is added to 100% of the sample plastic until the sample plastic partially dissolves into the Heptane.

CA<100%>+Cellulose<100%>=CB (2)

According to Equation (2), cellulose is added to CA until the molecular weight of the quantity of cellulose being added equals the molecular weight of CA.

CB<100%>+Methyl rhenium trioxide<50%>=CC (3)

According to Equation (3), methyl rhenium trioxide is added to CB until the molecular weight of the quantity of methyl rhenium trioxide being added equals half the molecular weight of CB.

CC<100%>+Butylated hydroxytoluene<15%>=CD (4)

According to Equation (4), butylated hydroxytoluene is added to CC until the molecular weight of the quantity of butylated hydroxytoluene being added equals 15% of the molecular weight of CB.

CD<100%>+Polyphenol oxidase<75%>=BA (5)

According to Equation (5), polyphenol oxidase is added to CD until the molecular weight of the quantity of polyphenol oxidase being added equals 75% of the molecular weight of CD.

BA<0.1%>+PD<100%>=Final commercial-production plastic (6)

SP=clients' needs. (0.1% is equivalent to an inverse factor (additive/plastic's mass) of 1.

BA is the final TIMEPLAST additive. Once BA is created, 0.1% of the molecular weight of the amount of plastic desired to be produced is added in the form of the additive BA.

The above molecular weight percentages are believed to be the most effective amounts. Each molecular weight percentage still can work in a +/−5% range. To illustrate, the percentage of the molecular weight in added cellulose can be within the range of 90% and 100% and still function Similarly, the percentage of methyl rhenium trioxide can be in the range of 45%-55% and function. The percentage of butylated hydroxytoluene can be within the range of 10%-20% and still function; and the percentage of polyphenol oxidase can be within the range of 70%-80% and still function. The amount of additive to be added to the amount of plastic sought to be produced can range between 0.09% and 1%.

The TIMEPLAST is blended with the carrier, the combining additive, and the brightener. The resulting composition is introduced as an additive to a predetermined plastic production demand. The resulting plastic, homogenized with the composition, has weaker links susceptible to oxidation, water degradation, and biodegradation.

The destabilizer is pre-dispersed into an oil-based liquid carrier, along with the combining additive and the brightener, to form the inventive composition. The carrier enables the destabilizer to be metered into a continuous plastic process such as extrusion or injection molding.

The liquid carrier can be, for example, cottonseed oil.

The liquid carrier must be compatible with the plastic resin to which the composition will be added. When selecting a liquid carrier, certain characteristics are desirable, while other characteristics must be avoided.

Surfactants, or “soap-like” carriers, can cause “slip” between the screw and the plastic resin during the molding or extrusion process. While slip is to be avoided, however, lubrication of the screw and barrel of injection molding and extrusion equipment is sometimes needed.

The liquid carrier must not break down at the high temperatures required in the molding or extrusion process that melt the plastic resin.

A carrier liquid that imparts an odor to the final part cannot be used when molding or extruding products to be used to contain food, such as plastic water bottles.

Cost and availability of the carrier liquid typically are factors.

Cottonseed oil is superior to other carriers in meeting a number of the above requirements.

Cottonseed oil has a relatively high flash point, and a high smoke point, well above 400° F. Most other liquid carriers smoke below 400° F.

Cottonseed oil has very little odor. Cottonseed oil is known to be used as a cooking oil that does not impart flavor to the food being cooked. This is a benefit when molding or extruding plastic products used for food packaging.

Cottonseed oil is high in antioxidants, providing an advantage in preserving products packaged in plastic that has been molded or extruded using a cottonseed oil carrier for the liquid color providing the color for the product packaging.

Cottonseed oil is high in vitamin “E,” an antioxidant, which often is required as an additive when using other carriers.

Cottonseed oil is available in bulk qualities, and is competitively priced.

Cottonseed oil gives the finished plastic product greater strength and impact resistance. For example, it is believed that a plastic material containing two percent by weight of cottonseed oil will have significantly greater strength than that same material without cottonseed oil.

Also, the presence of two percent by weight of cottonseed oil in the finished plastic product provides a measure of lubricity between the screw and the barrel in injection molding and extrusion machinery.

The combining additive facilitates combining of the destabilizer and the oil-based carrier.

The optical brightener improves the appearance of the finished plastic product by producing a whitening effect in the plastic. Also, it is preferable that the optical brightener fluoresce when exposed to ultraviolet light. Because TIMEPLAST is not visible in the finished plastic product, the fluorescence of the optical brightener can provide a visual indication that the optical brightener is present in the finished plastic product, which in turn provides an indirect indication that the TIMEPLAST is present in the finished product.

In one of its aspects, the disclosed technology provides a method of fabricating a plastic article, the method including preparing a mixture, where the mixture preferably comprises solid plastic resin pellets; and a composition comprising a destabilizing agent and an oil-based liquid carrier; and thereafter forming the mix preferably under pressure and heat into the plastic article. The method may be accomplished, for example, either by injection molding or by extrusion. The liquid carrier can be cottonseed oil; and the destabilizing agent can be TIMEPLAST™. The composition used in the method may further comprise an additive that facilitates combining of the destabilizing agent and the liquid carrier; and an optical brightener. In other variants of the inventive method, the composition can include pigment, so that the composition can act as a liquid colorant that causes biodegradation in the plastic to which the colorant is added.

In another aspect, the disclosed technology provides a composition for use in molding or extruding plastic products where the composition preferably includes a destabilizing additive such as TIMEPLAST; an oil-based liquid carrier, such as cottonseed oil, that facilitates introduction of the destabilizing agent into a continuous plastic-making process; at least one additive that facilitates combining of the destabilizing additive and the liquid carrier; and an optical brightener, with the destabilizing agent, the additive, and the optical brightener preferably being dispersed together in the cottonseed oil.

In another aspect, the disclosed technology provides a liquid colorant for use in molding or extruding plastic products, where the liquid colorant causes biodegradation in the plastic to which the colorant is added. The colorant preferably comprises pigment and a biodegrading agent dispersed in cottonseed oil; and an additive that facilitates combining of the destabilizing agent and the liquid carrier.

The dispersion of the pigment in the cottonseed oil is preferably milled by passing the liquid through a mill to break down any agglomerates of pigment that may remain in the single pigment dispersion, thereby reducing particle size of the pigment to as small a size as possible. The resulting particles of pigment powder are very, very small, producing the fullest, richest color. Milling the single pigment dispersion allows use of less pigment to perform the particular coloring function, thereby reducing costs. The milling may be done using a roller mill or a sand mill. Both roller mills and sand mills are common industrial mills. A single pigment dispersion is specified for illustrative purposes only. The inventive principles also can be applied to multi-pigment dispersions.

The cottonseed oil has been found to hold the pigment powder particles in suspension very well and accepts a high loading of pigment.

The inventive compositions can be made as follows. Once the formula has been established for the amounts of destabilizing agent, cottonseed oil, additive, optical brightener, and optional pigment, the amounts of these constituents are selected in amounts required in the formula. The liquid carrier in the form of cottonseed oil is provided in an amount according to the formula, and the destabilizing agent, additive, brightener, and pigment are then blended, preferably but not necessarily all at once, into the cottonseed oil to produce a required composition.

It is believed that the composition produced in accordance with the disclosed technology can be used to provide biodegradability to most commercially used thermoplastics, whether processed by means of extrusion, injection molding or blow molding, as well as thermoplastics that are processed using less conventional processes. When properly formulated, the composition according is not just compatible with a base resin but, due to the presence of the cottonseed oil, the composition frequently improves the fabricating process and/or the performance properties of the fabricated plastic parts and adds strength to the finished plastic product; can provide lubricity to the resin as it is extruded; and facilitates biodegradation of the finished plastic parts.

The range of thermopolymers with which the composition of the invention may be used is believed to be quite broad, and includes acrylic, nylon, acrylonitrile butadiene styrene, polycarbonate, polybenzimidazole, polyether sulfone, polyetheretherketone, polyetherimide, polyethylene, polypropylene, polyphenylene sulfide, polyphenylene oxide, polystyrene, polyvinyl chloride, polytetrafluoroethylene, as well as others.

The following examples further certain aspects of the disclosed technology and the practice thereof.

### Example 1

A mixture of 38 percent winterized cottonseed oil, 25 percent green pigment, and 37 percent of a destabilizer was prepared, resulting in a green solution of a hue known to produce a desired green color in finished molded or extruded plastic parts. All percent figures are percent by weight. The solution was added to polymeric resin material, specifically polyvinyl chloride, at a ratio of 98% resin to 2% solution, again by weight, to produce a blend which was introduced into an injection molding machine and molded into finished plastic parts. The finished plastic parts were of the desired green color throughout.

### Example 2

A mixture of 38 percent winterized cottonseed oil, 25 percent black pigment, and 36 percent of a foaming agent was prepared, resulting in a black solution known to produce stark uniform black color in finished molded or extruded plastic parts. All percent figures are percent by weight. The solution was added to polyethermide resin at a ratio of 98% resin to 2% solution, again by weight, to produce a blend which was introduced into an injection molding machine and molded into finished plastic parts. The finished plastic parts were uniform, of the desired stark black color throughout.

### Example 3

A mixture of 57 percent winterized cottonseed oil, 42 percent yellow pigment, and 1 percent antimicrobial agent was prepared, resulting in a yellow solution to produce yellow color in finished molded or extruded plastic parts. All percent figures are percent by weight. The solution was added to polytetrafluoroethylene resin at a ratio of 98% resin and 2% blend, again by weight, to produce a blend which was introduced into an injection molding machine and molded into finished plastic parts. The finished plastic parts exhibited the desired shade of uniform yellow color throughout.

### Example 4

A mixture of 48 percent winterized cottonseed oil, 20 percent blue pigment, and 32 percent of a destabilizer was prepared, resulting in a blue solution known to produce a uniform desired shade of blue in molded plastic parts. All of the percent figures are percent by weight. The solution mixture was added to polystyrene resin at a ratio of 98% resin and 2% blend, again by weight, to produce a blend which was introduced into an injection molding machine and molded into finished plastic parts. The finished plastic parts exhibited the desired shade of blue color throughout.

### Example 5

A mixture of 12 percent winterized cottonseed oil, 77 percent white pigment, 10 percent of an antioxidant, and 1 percent of an antimicrobial was formulated to produce white plastic parts when molded. All the percent figures are percent by weight. The mixture was added to granular PCR resin at a ratio of 98% resin and 2% blend, again by weight, to produce a blend which was introduced into an injection molding machine and molded into finished plastic parts. The finished plastic parts were white throughout.

This invention may be embodied in other specific forms without departing from the spirit or essential characteristics of the invention. The disclosed embodiments are therefore to be considered in all respects as being illustrative and not restrictive with the scope of the invention being indicated by the appended claims rather than by the foregoing description. All changes which come within the meaning and range of equivalency of the claims are therefore intended to be embraced therein.

As discussed above and from the foregoing description of the exemplary embodiments of the invention, it will be readily apparent to those skilled in the art to which the invention pertains that the principles and particularly the composition and methods disclosed herein can be used for applications other than those specifically mentioned. All such applications of the invention are intended to be covered by the appended claims unless expressly excluded therefrom.

As used in the claims below, “comprising” means “including” while “consisting of” means “having only”, and “consisting essentially of” means having the stated constituents plus trivial amounts of other reagents which do not materially affect the claimed invention or products embodying the same.

The scope of the invention is, therefore, indicated by the appended claims rather than by the foregoing description and all changes which come within the range of equivalency of the claims are to be considered to be embraced within the scope of the claims. Additional objects, other advantages, and further novel features of the invention will become apparent from study of the appended claims as well as from study of the foregoing detailed discussion and description of the preferred embodiments of the invention, as that study proceeds.

We claim:

1. A composition for use in molding or extruding plastic products, comprising a liquid carrier and a destabilizer.

2. The composition of claim 1, further comprising an optical brightener.

3. The composition of claim 1, wherein the destabilizer comprises TIMEPLAST™.

4. The composition of claim 1, wherein the liquid carrier comprises cottonseed oil.

5. The composition of claim 1, further comprising an additive that facilitates combining of the liquid carrier and the destabilizer.

6. The composition of claim 1, further comprising pigment.

7. The composition of claim 2, wherein the optical brightener is configured to fluoresce when exposed to ultraviolet light.

8. The composition of claim 1, wherein the destabilizer is configured to cause a decrease in the molecular weight of a polymer.

9. A liquid colorant for use in manufacturing plastics, comprising: a destabilizer; a liquid carrier; and pigment.

10. The liquid colorant of claim 9, wherein the destabilizer comprises TIMEPLAST™.

11. The liquid colorant of claim 9, wherein the liquid carrier comprises cottonseed oil.

12. The liquid colorant of claim 9, further comprising an additive that facilitates combining of the liquid carrier and the destabilizer.

13. The liquid colorant of claim 12, wherein the destabilizer is configured to cause a decrease in the molecular weight of a polymer.

14. A method of molding or extruding plastic parts comprising the steps of:
a) providing a quantity of destabilizer;
b) providing a quantity of liquid carrier;
c) combining the destabilizer and the liquid carrier to produce a composition; and
d) adding the composition to thermoplastic resin in the course of molding or extrusion.

15. The method of claim 14, further comprising providing an optical brightener; and
combining the destabilizer, the liquid carrier, and the optical brightener to produce the composition.

16. The method of claim 15, further comprising providing an additive that facilitates combining the liquid carrier and the destabilizer; and combining the destabilizer, the liquid carrier, the optical brightener, and the additive to produce the composition.

17. The method of claim 14, wherein the destabilizer comprises TIMEPLAST™.

18. The method of claim 14, wherein the liquid carrier comprises cottonseed oil.

19. The method of claim 15, wherein the optical brightener is configured to fluoresce when exposed to ultraviolet light.

20. The method of claim 14, wherein the destabilizer is configured to cause a decrease in the molecular weight of a polymer.

21. The method of claim 14, further comprising providing pigment; and combining the destabilizer, the liquid carrier, and the pigment to produce the composition, wherein the composition is a liquid colorant.

22. A method of molding or extruding plastic parts comprising the steps of:
a) providing a collection of pigments in powder form;
b) providing a quantity of cottonseed oil;
c) providing a quantity of destabilizer;
d) creating a plurality of single pigment dispersions each in a cottonseed oil carrier, the cottonseed oil carrier comprising the cottonseed oil and the destabilizer;
e) blending selected ones of the single pigment dispersions to create a blend of a desired color shade;
f) milling the blend; and
g) adding the blend to thermoplastic resin in the course of molding or extrusion.

23. The method of claim 22, wherein the pigment in each of the dispersions comprises from about 50% to about 70% by weight of the dispersion.

24. The method of claim 22, wherein the pigment in each of the dispersions comprises from about 25% to about 80% by weight of the dispersion.

25. The method of claim 22, wherein the pigment in the blend of the dispersions comprises from about 25% to about 80% by weight of the blend.

26. A method of making liquid color for use in the course of molding or extruding plastic parts comprising the steps of:
a) providing a collection of pigments in powder form;
b) providing a quantity of cottonseed oil;
c) providing a quantity of destabilizer;
d) creating a plurality of single pigment dispersions, each in a cottonseed oil carrier; the cottonseed oil carrier comprising the cottonseed oil and the destabilizer;
e) blending selected ones of the single pigment dispersions to create a blend of a desired color shade; and
f) milling the blend.

27. The method of claim 26, wherein the pigment in the blend of the dispersions comprises from about 25% to about 80% by weight of the blend.

28. The method of claim 26, further comprising adding at least one additive selected from the group comprising lubricants, blowing agents, light stabilizers, nucleating agents, antistatic agents and antioxidants, to the blend.

29. A method of fabricating plastic products having a preselected color, comprising:
a) preparing a dispersion of pigment of the preselected color in cottonseed oil and destabilizer;
b) supplying a preselected plastic resin for the product to be fabricated to a process machine having a rotating screw;
c) furnishing the dispersion to the process machine at a position adjacent to threaded portion of the rotating screw; and
d) blending the dispersion and the resin by rotating the screw.

30. A plastic part manufactured by the method of claim 14.

31. A plastic part manufactured by the method of claim 22.

32. A liquid color manufactured by the method of claim 26.

33. A plastic product manufactured by the method of claim 29.
